(19) United States
(12) Patent Application Publication
(10) Pub. No.: US 2023/0241843 A1
(43) Pub. Date: Aug. 3, 2023

(54) ENHANCED FRACTURE TOUGHNESS OF BONDED JOINTS USING TAILORED SACRIFICIAL CRACKS

(71) Applicant: KING ABDULLAH UNIVERSITY OF SCIENCE AND TECHNOLOGY, Thuwal (SA)

(72) Inventors: Ahmed WAGIH, Thuwal (SA); Gilles LUBINEAU, Thuwal (SA)

(21) Appl. No.: 18/009,870

(22) PCT Filed: Jun. 16, 2021
(86) PCT No.: PCT/IB2021/055332

§ 371 Date: Dec. 12, 2022

Related U.S. Application Data
(60) Provisional application No. 63/042,102, filed on Jun. 22, 2020.

(51) Int. Cl. B29C 65/48; B29C 65/82; B29C 65/00

(52) U.S. Cl. CPC B29C 65/48; B29C 65/82; B29C 66/45

(57) ABSTRACT

An adhesive-based joint includes a first adherend, a second adherend, an adhesive layer located between the first adherend and the second adherend, and plural strip parts of a low adhesive material embedded into the adhesive layer. The low adhesive material has an adhesion with the adhesive layer lower than an adhesion between the first or second adherend and the adhesive layer.

### CROSS-REFERENCE TO RELATED APPLICATIONS

This application claims priority to U.S. Provisional Pat. Application No. 63/042,102, filed on Jun. 22, 2020, entitled “IMPROVED TOUGHNESS OF ADHESIVELY BONDED COMPOSITE JOINTS USING TAILORED SACRIFICIAL CRACKS,” the disclosure of which is incorporated herein by reference in its entirety.

### BACKGROUND

### Technical Field

Embodiments of the subject matter disclosed herein generally relate to a system and method for improving a fracture toughness in bonded joints, and more particularly, to activate extra nonlocal dissipation damage mechanisms by inserting sacrificial cracks inside an adhesive used for the bonding process.

### Discussion of the Background

Most composite structures are made by combining smaller parts that are manufactured separately. Mechanical fastening, and adhesive bonding are the most common ways for this purpose. Traditional fasteners usually require drilling holes in the structure and different machining processes, which might cause initial internal damage in the composite part, such as matrix cracks and delaminations. Moreover, cutting the fibers causes a decrease in the load carrying capacity of the part, which requires extra material, and thus increases the structure weight. Bonded joints between the composite parts are increasingly popular alternatives to mechanical joints in engineering applications due to their advantages over conventional mechanical fasteners. Among these advantages are lower stress concentrations, increased strength-to-weight efficiency, and improved damage tolerance. The application of these joints in structural components made of fiber reinforced composites has increased significantly in recent years. However, the catastrophic failure of these joints limits their application as a primary joining technique for structural applications. These adhesive joints usually fail in an unstable manner once a crack is initiated because the crack can propagate very rapidly, thus causing catastrophic failure. To this end, efforts have been made in the field to arrest crack propagation, not only by improving the adhesive-adherend interface toughness, but also by improving the R-curve response of these joints, so catastrophic failure can be avoided.

Several techniques are known in the art for improving the fracture toughness of bonded joints. It is understood herein that a bonded joint involves at least two parts (for example, composite made parts) that are attached to each other by using an adhesive. These techniques can be characterized as adherend-based modifications and adhesive-based modifications. The adherend-based modifications mainly increase the surface roughness of the adherend using methods such as sanding, grit blasting, and peel-ply, which allows better adhesion at the interface and thus improves interface toughness. Despite the effectiveness of sanding and grit blasting to produce relatively rough surfaces, the joints are still not reliable because both methods are manually operated, which introduces a large variation in the joint strength and toughness. Moreover, these techniques can cause fiber damage at the interface, which reduces the adherend strength. Peel-ply is applied to overcome the disadvantages of these techniques; however, its applicability for large structures is limited because it must be applied before adherend curing. Recently, UV, CO2 and femtosecond laser treatment have been applied to increase the adherend surface roughness. A previous study proposed the application of CO₂ laser treatment with alternating high and low energy for both adherends to produce two different surface roughness, which activates nonlocal damage mechanisms. These damage mechanisms dissipate higher energy during propagation, which improves the fracture toughness. Additionally, the same treatment strategy has been applied to improve the mode I fracture toughness.

On the other hand, an adhesive-based modification was proposed in several studies, including z-pinning and stitching, adding ceramic additives and thermoplastic inclusions. However, although z-pinning and stitching improve the fracture toughness of a bonded joint, the in-plane strength and stiffness are highly reduced due to the fiber waviness.

Another approach consists in tailoring the microstructure of the composite to improve a particular property. This method is sometimes applied for composites to improve their fracture toughness. For example, the authors in [1] reported an improved fracture toughness with a large array of microcracks parallel to the main crack. The toughness improvement was due to the dissipation of the energy in these microcracks and their elastic deformation. Recently, Bullegas et al. (Engineering the translaminar fracture behaviour of thin-ply composites, Composites Science and Technology 2016;131:110–22.) applied the same philosophy to improve the translaminar fracture toughness of thin-ply laminates. These authors achieved a 3-fold improved fracture toughness by generating microcracks with certain patterns along the crack path. Another group embedded a woven copper mesh inside the adhesive of a metallic bonded joint with a sequential insertion of defects on alternating surfaces of adherends to improve the fracture toughness of bonded joints.

However, the fracture toughness of the existing bonded joints needs further improvement. Thus, there is a need for a new structure to increase the fracture toughness of the bonded joints.

### BRIEF SUMMARY OF THE INVENTION

According to an embodiment, there is an adhesive-based joint that includes a first adherend, a second adherend, an adhesive layer located between the first adherend and the second adherend, and plural strip parts of a low adhesive material embedded into the adhesive layer. The low adhesive material has an adhesion with the adhesive layer lower than an adhesion between the first or second adherend and the adhesive layer.

According to another embodiment, there is a joint that includes a first adherend, a second adherend, an adhesive layer located between the first adherend and the second adherend, and plural sacrificial cracks embedded into the adhesive layer. The plural sacrificial cracks are filled with a low adhesive material that has an adhesion with the adhesive layer lower than an adhesion between the first or second adherends and the adhesive layer.

According to still another embodiment, there is a method for manufacturing a joint with offset of sacrificial cracks from a mid-plane, and the method includes providing a first adherend, providing a second adherend, applying a first sub-layer of adhesive on the first adherend, applying a second sub-layer of adhesive on the second adherend, applying a thin film of a low adhesive material onto the first sub-layer of adhesive, wherein the thin film has plural sacrificial cracks, sandwiching the thin film between the first sub-layer of adhesive and the second sub-layer of adhesive to form an adhesive layer that includes the plural sacrificial cracks, and curing the formed joint. The low adhesive material has an adhesion with the adhesive layer lower than an adhesion between the first or second adherends and the adhesive layer.

### BRIEF DESCRIPTION OF THE DRAWINGS

For a more complete understanding of the present invention, reference is now made to the following descriptions taken in conjunction with the accompanying drawings, in which:

FIGS. 1A and 1B are side and top schematic diagrams, respectively, of a joint made of adhesive bonded parts, the adhesive including sacrificial cracks;

FIGS. 2A to 2D illustrate the steps for forming the joint with sacrificial cracks;

FIG. 3 illustrates another joint made of adhesive bonded parts where the adhesive has sacrificial cracks distributed at different heights;

FIG. 4 illustrates a setup for testing the joint with sacrificial cracks under various displacements applied for end-notch flexure tests;

FIG. 5 illustrates various samples considered for the end-notch flexure tests (ENF);

FIG. 6A illustrates the load-displacement and the effective crack length-displacement curves for a baseline sample, FIG. 6B illustrates the mode II energy release rate-effective crack length (R-curve) for the baseline sample, FIG. 6C illustrates the load-displacement and the effective crack length-displacement curves for the joint with the sacrificial cracks, and FIG. 6D illustrates the mode II energy release rate-effective crack length (R-curve) for the joint with the sacrificial cracks;

FIGS. 7A to 7E illustrate the progression of a secondary crack and a backward crack that appear at the sacrificial cracks when a primary crack is generated in the joint under ENF test;

FIG. 8 illustrates the maximum load and mode II toughness measured for the joint with sacrificial cracks and baseline samples under ENF test;

FIGS. 9A and 9B illustrate the load versus displacement and the mode I fracture toughness versus effective crack length for the joint with sacrificial cracks and baseline samples under DCB test;

FIGS. 10A to 10C illustrate the damage mode in joints with sacrificial cracks embedded with different offset from the mid-plane during DCB test;

FIGS. 11A and 11B illustrate the effect of the sacrificial crack width on the mode I toughness;

FIGS. 12A and 12B illustrate the effect of the gap between the sacrificial cracks on the joint;

FIGS. 13A to 13C illustrate the effect of the adhesive strength on the joint;

FIGS. 14A and 14B illustrate the effect of the adhesive failure strain on the joint; and

FIG. 15 is a flow chart of a method for manufacturing a joint with plural sacrificial cracks.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to two composite parts that are joined together with an adhesive layer. However, the embodiments to be discussed next are not limited to such a structure, but may be applied to other joints that include different materials, for example, a metal and a composite or two metals, etc.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, tailored sacrificial cracks are generated inside the adhesive bondline to improve modes I and II fracture toughness of secondary bonded joints. A secondary bonded joints refers to two different parts being bonded with an adhesive while a primary bonded material is a material, usually a composite, which is made by bonding together various fibers. In this embodiment, the sacrificial cracks are generated by using a polytetrafluoroethylene (PTFE) film that has a given width and thickness. The PTFE film is cut to have plural strip parts and these parts are fully embedded, in one embodiment, in the adhesive layer to generate these sacrificial cracks during the bonding process. Thus, the sacrificial cracks are spaces devoid of the adhesive while partially or fully enclosed by the adhesive. While these spaces, i.e., the sacrificial cracks, are shown in the following figures as being filled with the PTFT film, in other embodiments, they may be empty. However, in other embodiments, the PTFE film may be replaced with other materials that exhibit a low adherence to the adherent used to join the parts. A low adherence is defined herein as an adherence lower than an adherence between the adherend and the adhesive. Thin and thick adhesives with thicknesses of 0.3 and 0.8 mm are used to identify the applicability range of the proposed novel technique.

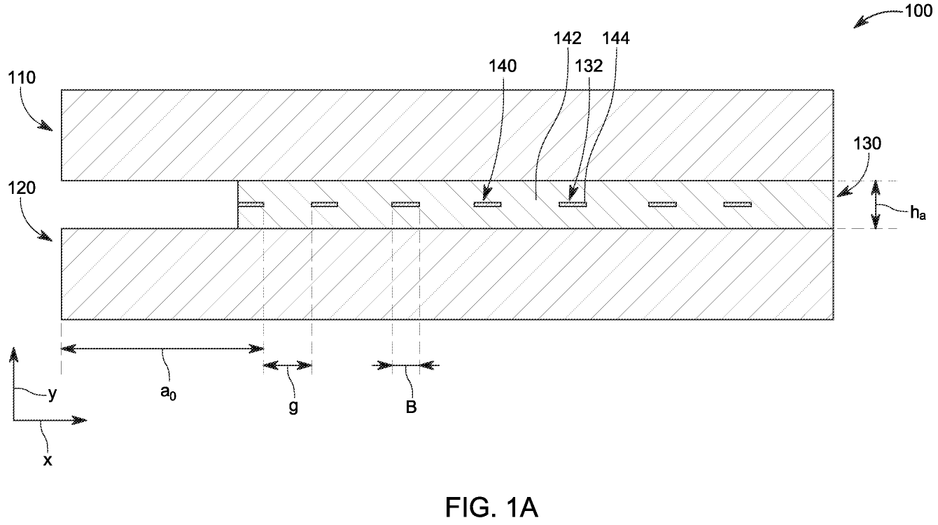

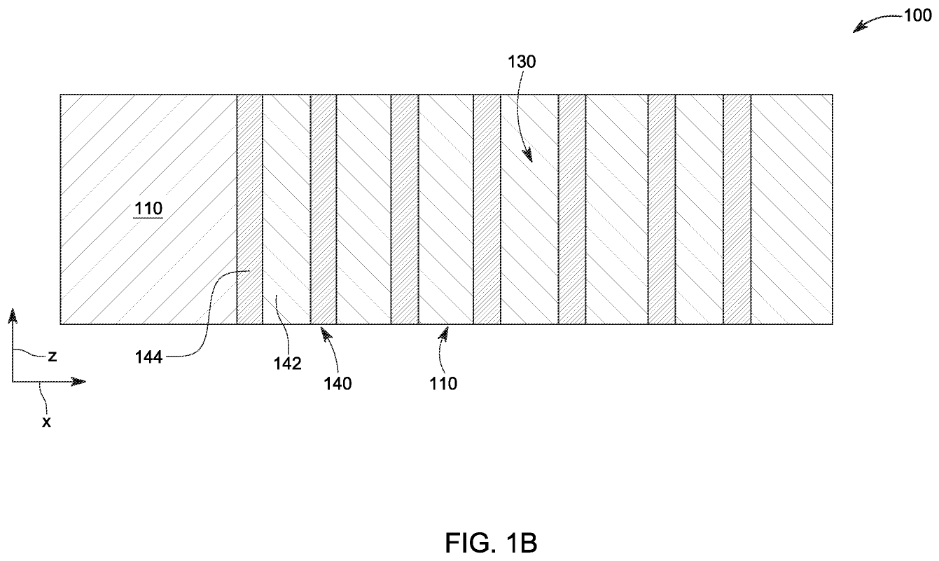

To manufacture a joint 100 having the features noted above, according to the embodiment illustrated in FIGS. 1A and 1B, each of the two adherends 110 and 120 were made using unidirectional tape prepreg carbon/epoxy. In other words, the adherends in this embodiment are composite materials. These composite materials or composite parts may be used in the aeronautic industry, boating industry, etc. In this embodiment, the hand lay-up technique was used to stack eight plies of 0.25 mm thickness to produce the adherends 110 and 120 with [0°]₈ stacking sequence and an overall 2 mm thickness. After laying up the 300 × 300 mm² panels, a compression molding was used to cure these plates together. The samples were compressed in this embodiment at 7 bar pressure and 180° C. for 2 h using a hydraulic hot press that was programmed with constant heating and cooling rates of 3° C./min. Note that other values are possible for these parameters. The ASTM standard recommendations were followed to characterize the elastic material properties of the manufactured adherends, which are summarized as follows: in-plane elastic modulus, E₁₁ = 135 ± 6 GPa; out-of-plane elastic modulus, E₂₂ = 8.75 ± 0.27 GPa; in-plane shear modulus, G₁₂ = 4.93 ± 0.14 GPa; and in-plane Poisson’s ratio ʋ₁₂ = 0.29 ± 0.01.

An abrasive water jet machine was used to cut the adherends 110 and 120 from the manufactured panels. For example, 15 mm from the panel edges was trimmed to obtain the adherents. Then, three sub-panels of 270 × 90 mm² were cut from the panels and their major dimension was aligned with the 0° direction.

In one application, a uniform laser treatment was applied, using CO₂ pulsed laser, to the adherends 110 and 120′s surfaces to improve adhesion between the adhesive and the adherend. However, this step is optional and not required for the sacrificial cracks to be discussed. The parameters that may be used for the laser treatment were: focal distance = 50 mm, Spot diameter = 200 µm, speed = 500 mm/s, pulse frequency = 20 kHz, and laser power = 22.5 W. Other values may be used with the same or similar effect. After this step, the sub-panels were submerged for 10 min in acetone, then dried at 60° C. for 30 min and air-cleaned.

Next, a PTFE film 140 was processed with a laser (the same or a different one) to create rectangular cutouts 142 that defined the sacrificial cracks 132 inside the adhesive layer 130. FIG. 1A shows the cutouts 142 and the transversal parts (strips) 144 from a side while FIG. 1B shows these elements from above. Note that FIG. 1B shows the adhesive layer 130 formed inside the cutouts 142, i.e., between the strip parts 144, prior to being attached to the second adherend 120. The strip parts 144 of the PTFE film 140 are shown in FIG. 1A having a width B and they define the sacrificial cracks 132 inside the adhesive layer 130 because they have very low adhesion with the adhesives (low adhesion in this embodiment is considered any adhesion that is lower than the adhesion between the adhesive and the adherend), while the adhesive material enters through the cutouts 142, which have a width g, as shown in FIG. 1A. In other words, the space 132 formed in the adhesive layer 130 by the strip parts 144 are the sacrificial cracks of the adhesive layer 130 and thus, the sacrificial cracks 132 have the same shape as the strip parts 144. While the strip parts 144 in the figures have a rectangular cross-section, it is also possible to shape them to have a spherical, or square, or trapezoidal or any other desired shape. In one embodiment, the strip parts 144 may be removed so that only the sacrificial cracks 132 are present in the adhesive layer 130.

For the adhesive layer 130, in this embodiment, Araldite 420 A/B adhesive having an elastic modulus = 1.5 GPa and a tensile strength = 36 MPa was used to bond the adherends 110 and 120 after laser treatment. The bonding process was performed in this embodiment in three steps. First, approximately half the thickness of the adhesive layer 130 was evenly spread over one of the adherends 110. Then, the PTFE film 140, with the cutouts, was placed over the first half of the adhesive layer. After that, the other half of the adhesive was spread over the second adherend 120 and the two adherends were bonded together. The bonded panels were then placed in a furnace at 60° C. for 30 min, under vacuum, and were kept at the same temperature for 3 hours without vacuum, followed by holding them at room temperature for 24 hours. Finally, each bonded panel was cut into samples of 260 mm × 25 mm to obtain the joints 100, where the major dimension is aligned with the fiber direction.

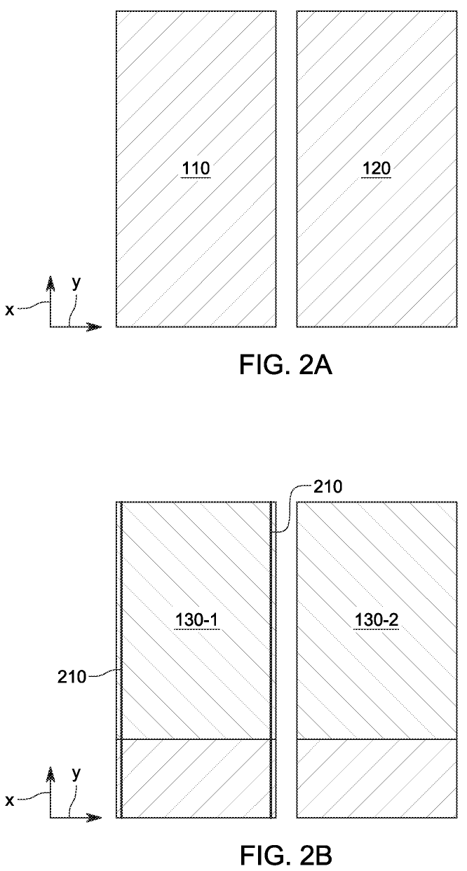

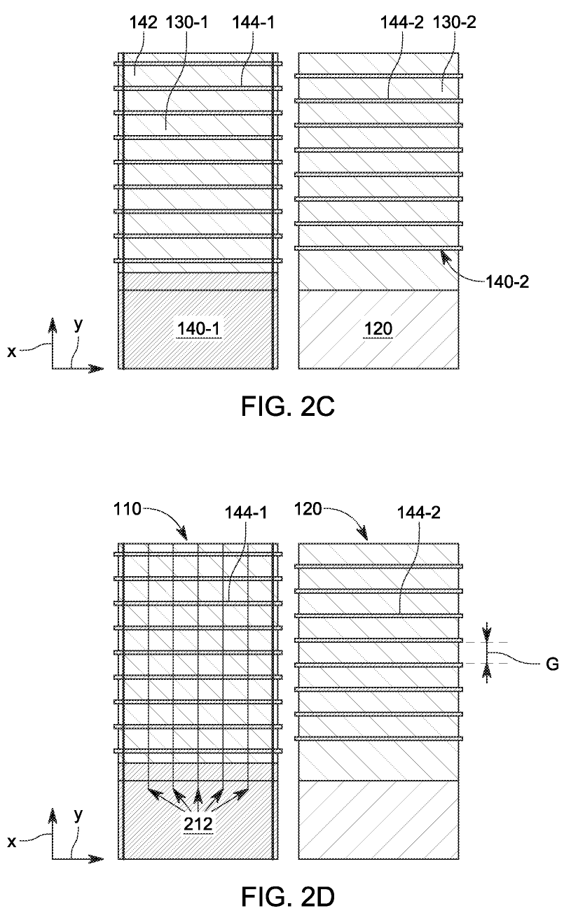

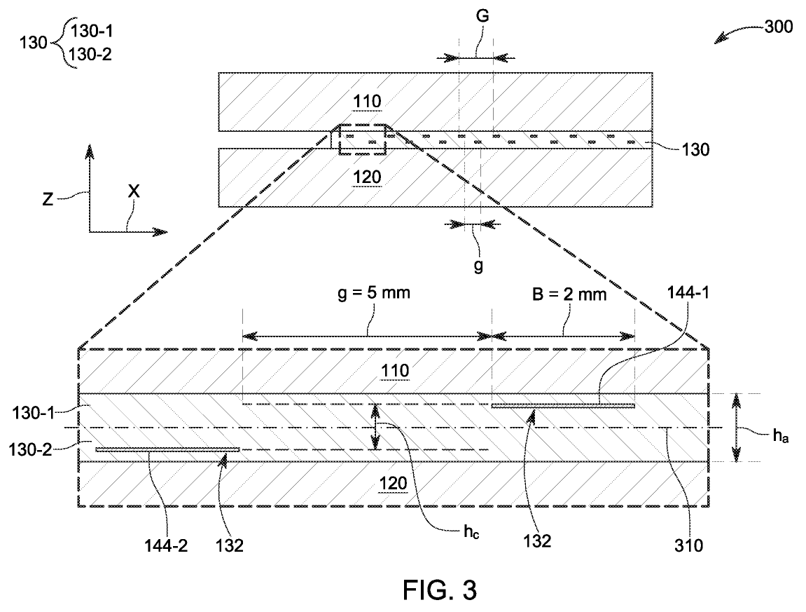

While the joint 100 in FIGS. 1A and 1B shows a single PTFE film 140 placed between the two adherends 110 and 120, it is also possible to use two PTFE films 140-1 and 140-2, as now discussed with regard to FIG. 2A to FIG. 3, to obtain a modified joint 300. The bonding process for this case was performed in four steps, as illustrated in FIGS. 2A to 2D. The first step is the treatment of the adherends 110 and 120 using a laser as previously stated and this step is illustrated in FIG. 2A. However, note that this step is optional and the invention can be applied without this step. The second step, which is illustrated in FIG. 2B, is the distribution of an equal amount of adhesive sub-layers 130-1 and 130-2 over each adherend, for example, reaching a thickness of 200 µm, which leads approximately to an adhesive thickness of 400 µm for the overall adhesive layer 130. In this step, a copper wire 210 of 400 µm diameter was used at the sub-plate 110’s edges to control the adhesive thickness. The thickness of the adhesive can be changed according to the needs and based on the experiments discussed below, for example, to be as thick as 1 mm.

In the third step, which is shown in FIG. 2C, two non-adhesive PTFE films 140-1 and 140-2 were added to each sub-layer 130-1 and 130-2, respectively and each of the PTFE film has, in this embodiment, a thickness of about 18 µm. This means that a thickness of the sacrificial cracks 132 is about 18 µm. In one application, the thickness of the sacrificial cracks 132 may be up to 100 µm. The PTFE films 140-1 and 140-2 were placed inside the adhesive bondline (in one embodiment, completely within the corresponding adhesive sub-layers 130-1 and 130-2) to create the sacrificial cracks. In this embodiment, a 60 mm long PTFE film was placed on each adherend to generate the initial cracks. Other lengths for the PTFE film may be used. Then, as shown in FIGS. 2D and 3, to generate an offset hc of the sacrificial cracks 132 from a mid-plane 310 (e.g., hc = 120 µm), copper wires 212 (for example, diameter of 120 µm) were placed over one of the adherends at 20 mm intervals across the plate width. Then, the final adhesive layer 130 was generated by contacting the sub-layers 130-1 and 130-2, with B = 2 mm (other values may also be used) so that a gap G between two successive strip parts 144 on each adherend was 12 mm (2 g + B), as shown in FIGS. 2D and 3.

After bonding the two adherends 110 and 120 with the adhesive sub-layers 130-1 and 130-2 to form the joint 300 as shown in FIG. 3, the PTFE films (with sacrificial cracks) 140-1 and 140-2 were stretched from both sides. As the joint 300’s width is 20 mm in this embodiment, the copper wires 212 were cut during sample cutting to form plural joints. After bonding, the bonded joints were placed in a furnace at 60° C. for 30 min under vacuum and at the same temperature for 3 hours without vacuum followed by holding at room temperature for 24 hours. It is noted that the sacrificial cracks 132 or the strip parts 144 in the joint 300 are formed above and below the mid-plane 310, which extends along the XY plane in FIG. 3, through the adhesive layer 130, equidistant from the first and second adherends 110 and 120. In one application, the sacrificial cracks 132 associated with the first adherent 110 are located at a distance hc/2 from the mid-plane 310, toward the first adherent while the sacrificial cracks 132 associated with the second adherent 120 are located at the same distance hc/2 from the mid-plane, toward the second adherent. In another application, the two distances are different. Note that a thickness of the adherent layer 130 is ha in this embodiment and the mid-plane 310 is located at ha/2 from each adherend. In this embodiment, the distance hc/2 can take any value between zero and a value smaller than ha/2. If hc is zero, then the joint 300 becomes the joint 100.

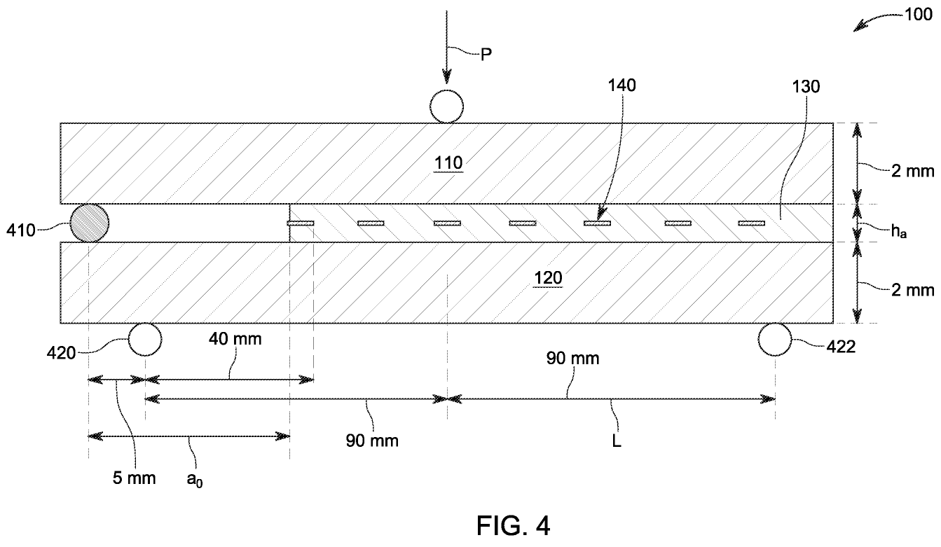

An end-notched flexure (ENF) test was used to characterize the mode II fracture toughness of the secondary bonded joint 100 with tailored sacrificial cracks 132. The ASTM D7905 standard was used for the sample size with slight modification on the ratio of the half-span length (L) to initial crack length (a₀) to achieve stable crack propagation. Others have reported that a a₀/L ratio should be equal or larger than 0.7 to achieve stable crack propagation. However, when this ratio was used for the joint 100 shown in FIG. 4, the crack propagation was not stable. As the art reports various values for this ratio, several trials have been performed to reach a ratio a₀/L that achieves stable crack propagation. It was found that a ratio of a₀/L = 0.44 achieved stable crack propagation for all the considered configurations. A steel wire 410 with a diameter equal to the adhesive layer 130’s thickness hₐ was placed between the two adherends 110 and 120, 5 mm from a first support 420, at the free edge of the joint 100, to ensure non-contact between the adherend’s ends. A second support 422 was provided at the other end of the joint 100. A displacement P was applied under a displacement control regime with a 0.5 mm/mm strain rate. A digital camera (not shown) was used to monitor the crack growth evolution from the sample edge. The in situ photos were synchronized with the load displacement data to explore the relationship between different external damage morphologies and the load-displacement response.

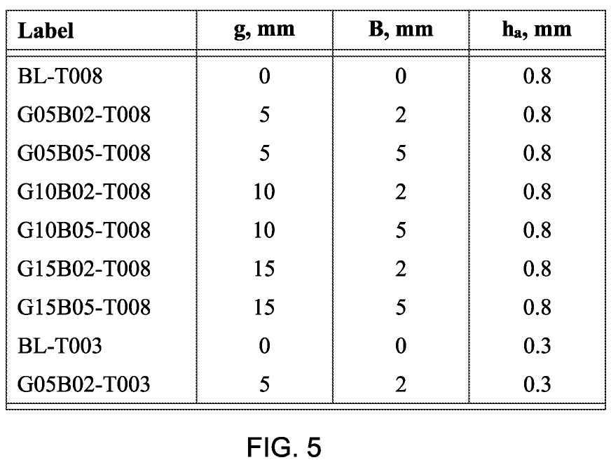

A test matrix as shown in FIG. 5 was designed to study the effect of the sacrificial crack 132’s width B (see FIG. 1A), and the gap g (see FIG. 1A) between two successive sacrificial cracks 132, and the adhesive thickness hₐ. Note that the BL stands in FIG. 5 for a baseline panel. The other entries in FIG. 5 indicate the gap g between consecutive sacrificial cracks 132, the length B of each sacrificial crack along the longitudinal direction X of the joint 100, and the thickness hₐ of the adhesive layer 130. A thickness ha of the adherent layer 130 is also shown in FIG. 5. Note that for the samples studied in the embodiments, the thickness of the adherent layer is smaller than 1 mm.

The effective crack length-based data-reduction method was used to overcome the difficulties of monitoring crack growth during loading. In the ENF test, due to the compressive stresses in the crack growth path, the crack tends to grow at the interface between the adherent and the adherend, while its surfaces are in contact. Moreover, the thick adhesive, 0.8 mm in some cases, leads to a large deformation in the Failure Process Zone (FPZ), which results in larger energy dissipation. Additionally, the high ductility of the adhesive contributes to the increasing FPZ, which also increases the energy dissipation. Therefore, the effective crack-length aₑ based data-reduction method is adequate in this embodiment because it considers all these dissipation mechanisms.

For determining the mode II fracture toughness of the joint 100 in this embodiment, the Timoshenko Beam Theory (TBT) was used to compute the specimen compliance under bending as follows:

$$C = \frac{δ}{P} = \frac{3 {a}^{2} + 2 {L}^{3}}{8 b {h}^{3} {E}_{f}} + \frac{3 L}{10 {G}_{13} b h} ,$$

where a is the length of the fracture (in FIG. 4, the length of the fracture is measured from the steel wire 410), b is the sample width, G₁₃ is the adherend flexural modulus and E_{f} is the equivalent flexural modulus. To calculate E_{f}, the initial crack length a₀ (see FIG. 4) and the initial compliance C₀ were substituted with values that were computed at the early stage of loading, which then leads to the equation:

$${E}_{f} = \frac{3 {a}_{0}^{3} + 2 {L}^{3}}{8 b {h}^{3}} {\left({C}_{0} - \frac{3 L}{10 {G}_{13} b h}\right)}^{- 1} ,$$

where the effective crack length aₑ was calculated using equation (1). By taking into account E_{f}, equation (2) can be written as a function of the specimen compliance as follows

$${a}_{e} = {\left[\frac{{C}_{c}}{{C}_{0 c}} {a}_{0}^{3} + \frac{2}{3} \left(\frac{{C}_{c}}{{C}_{0 c}} - 1\right) {L}^{3}\right]}^{1 / 3} ,$$

where

$${C}_{c} = C - \frac{3 L}{10 {G}_{13} b h} , a n d {C}_{0 c} = {C}_{0} - \frac{3 L}{10 {G}_{13} b h} .$$

According to the linear elastic fracture mechanism, the mode II fracture toughness G_{II} can be computed as:

$${G}_{I I} = \frac{{P}^{2}}{2 b} \frac{d C}{d a} .$$

By substituting equation (1) into equation (5), the direct relation between G_{II} and aₑ can be approximated as:

$${G}_{I I} = \frac{9 {P}^{2} {a}_{e}^{2}}{16 {b}^{2} {h}^{3} {E}_{f}} .$$

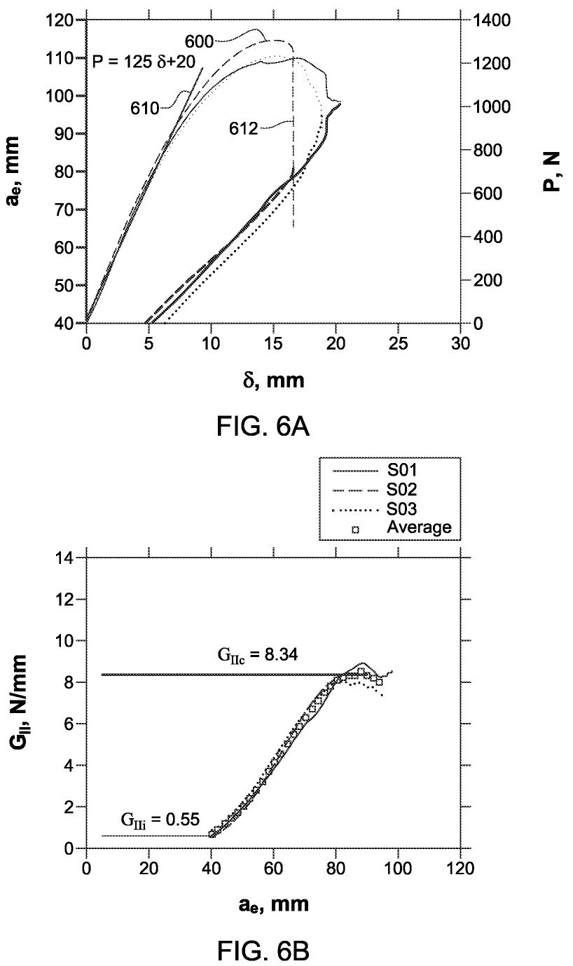

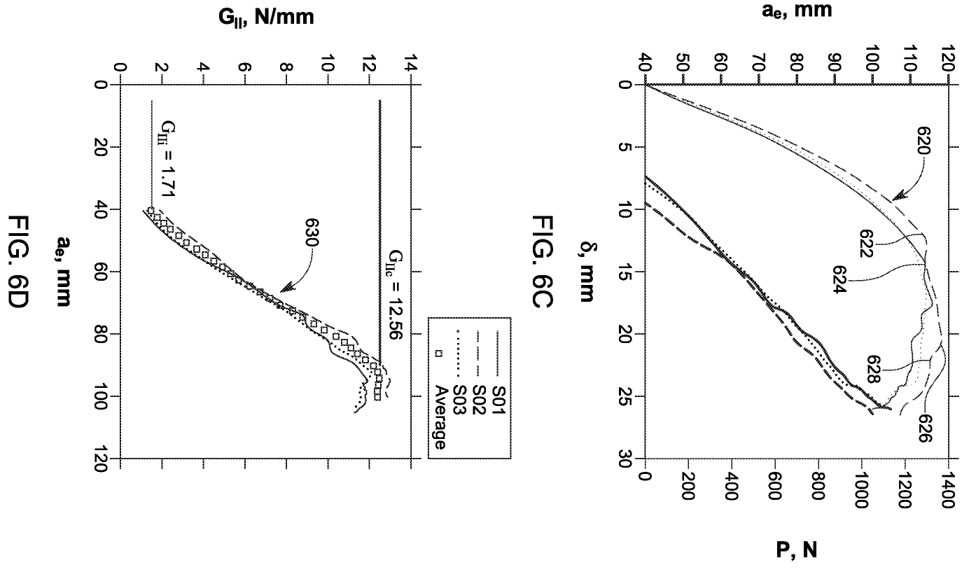

The results of various tests are illustrated in FIGS. 6A to 6D. FIG. 6A shows the load-displacement (P – δ) and the effective crack length-displacement (aₑ – δ) for the baseline joint BL-T008, while FIG. 6C shows the same quantities for the novel joint 100 characterized by G05B02-T008. FIG. 6B shows the mode II fracture toughness-crack length (G_{II}-aₑ) curves (R-curve) of the three samples tested for BL-T008 while FIG. 6D shows the same for the samples G05B02-T008. These figures confirm the good repeatability of the test with stable crack propagation. FIG. 6A shows the method of defining the crack initiation as the deviation of sample compliance (C) 600 from the initial fitted linear compliance (C₀) 610 of the sample. Once the sample compliance (C) 600 becomes 5% larger than the initial defined compliance (C₀= 1/125 mm/N, in S01) 610, the TBT method defines crack initiation. Note that due to plastic deformation in the adhesive layer 130 before crack initiation, the aₑ computed here using the TBT method is larger than the real crack length. The displacement and load at crack initiation is different due to the slight difference in stiffness between samples.

The R-curve computed using the TBT method shows in FIG. 6B a good repeatability for the three samples. From this figure, it is possible to extract two main characteristics: the initiation and propagation fracture toughness, G_{IIi} and G_{IIc}, respectively. The G_{IIi} is defined at the initiation of the crack, i.e., aₑ = 40 mm, while the G_{IIc} is defined when a fairly constant value of G(a) is achieved. The mean value of the three samples were computed and plotted in the figure. This mean value was used in the following subsections unless specifically stated otherwise.

Unlike the P – δ response 600 of the BL-T008 in FIG. 6A, at which the load increases up to a maximum value 612 and then decreases very quickly due to crack propagation, the P – δ response 620 of the G05B02-T008 joint 100 in FIG. 6C shows a load increase up to local maximum value at point 622 followed by a slight load decrease to point 624 and then another load increase at point 626 (descending stair steps). This cycle of increased load and then decrease is repeated until final failure takes place at δ = 25 mm. Moreover, the joint 100 shows a larger maximum load and displacement and aₑ at failure compared to the BL-T008 in FIG. 6A. The R-curve 630 of the G05B02-T008 in FIG. 6D is slightly different than the corresponding curve for the BL-T008 in FIG. 6B, where a stair step response is observed after aₑ being about 70 mm. Additionally, the G05B02-T008 joint shows larger G_{IIi} and G_{IIc} values. These differences in the P – δ and G_{II} -aₑ behavior suggest different damage mechanisms during the crack propagation, as now discussed.

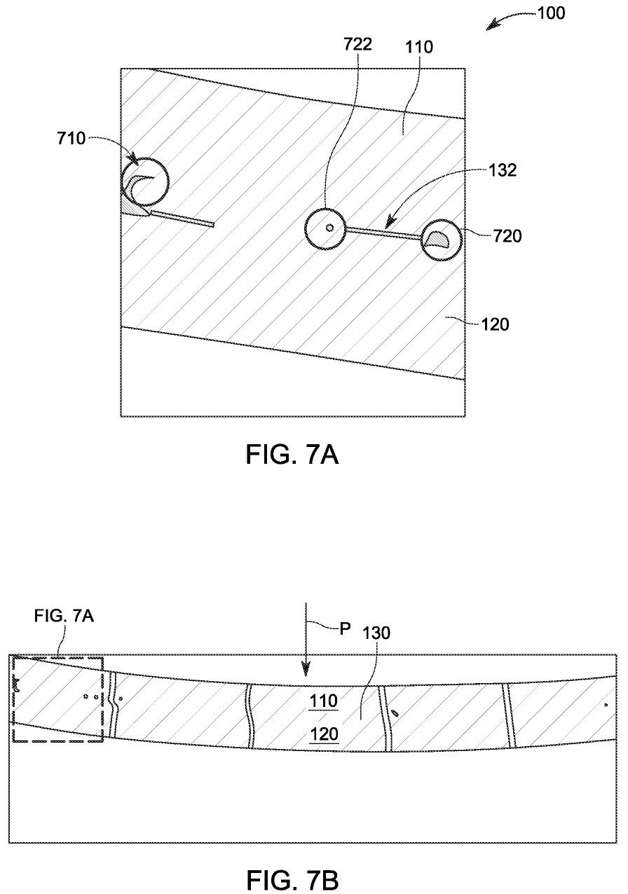

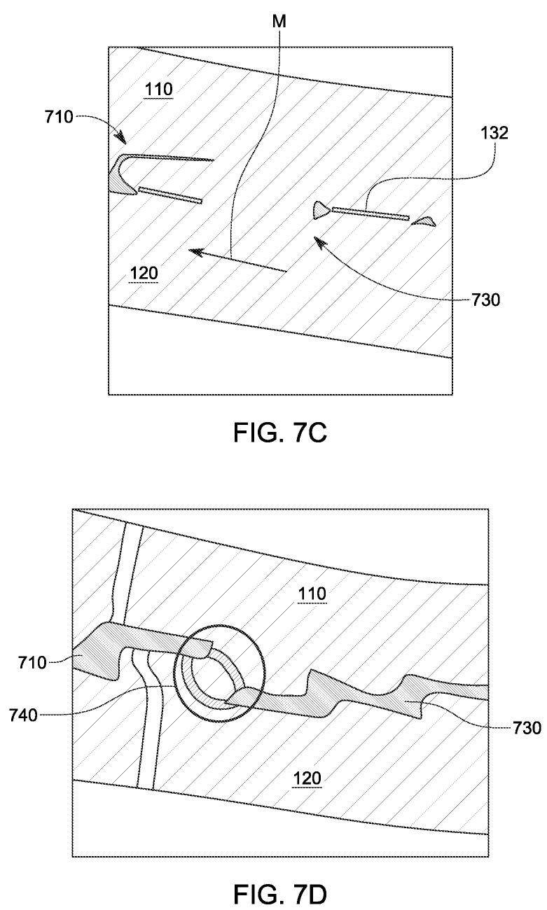

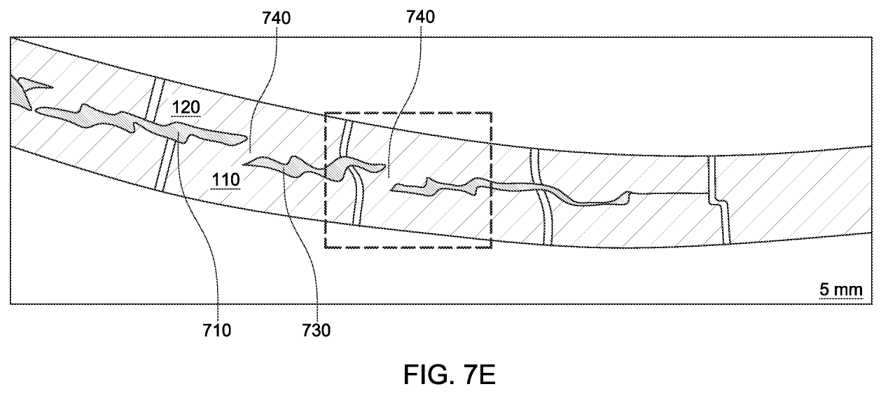

Returning to FIG. 6C, when the P – δ curve 620 reaches the first peak 622, the main crack initiates at its tip 710, as shown in FIG. 7A. FIG. 7A shows a small portion of the joint 100. The joint 100 is shown in FIG. 7B being deformed by the applied displacement P. The existence of the sacrificial crack 132, 5 mm away from the crack tip 710 generates two new spots 720 and 722 for stress concentration inside the FPZ. These new spots 720 and 722 redistribute stresses inside the FPZ, which reduces the stress concentration at the crack tip 710.

To propagate the main crack, more load had to be applied at the interface with the sacrificial film. This higher load achieves a larger initiation fracture toughness due to the higher deformation of the adhesive layer at the sacrificial crack. Once the crack initiates at point 622 in FIG. 6C, the load decreases until point 624, at which a secondary crack 730 initiates from the sacrificial crack 132 tip and propagates backward (in the opposite direction to the main crack propagation, along direction M) at the lower interface (between adherend 120 and the adherent 130), as shown in FIG. 7C. The secondary crack 730 arrests the crack propagation at the upper interface (between the adherend 110 and the adherent 130). The decrease in the load between points 622 and 624 corresponds to the small plateau in the R-curve at the same points.

Further increasing the applied displacement P, the load increases again while the backward secondary crack 730 grows, forming an adhesive ligament 740 until point 626, as shown in FIG. 7D. Between point 624 and point 626, the material dissipates energy to grow the secondary crack 730 at the lower interface and to elastically deform the adhesive ligament 740, which leads to an increased fracture energy from 6.4 N/mm at point 624 to 8.9 N/mm at point 626. At this point, the stress concentration at the next sacrificial crack tip reaches the interface strength, resulting in crack growth at the upper interface. The crack growth continues until point 628 (see FIG. 6C), resulting in a decreased load, at which another secondary crack grows backward at the lower interface.

The same scenarios between points 624 and 626 and between points 626 and 628 are then repeated, resulting in increased fracture energy and a plateau in the R-curve, respectively. Note that even when the main crack reaches the indented area at δ = 25.9 mm, the joint can sustain a high load due to the presence of the plural unbroken ligaments 740, as shown in FIG. 7E. The presence of these ligaments keeps the two adherends 110 and 120 in contact, which is not the case for the baseline joint, at which a complete separation between adherends occurs, resulting in a complete loss of the joint stiffness and strength.

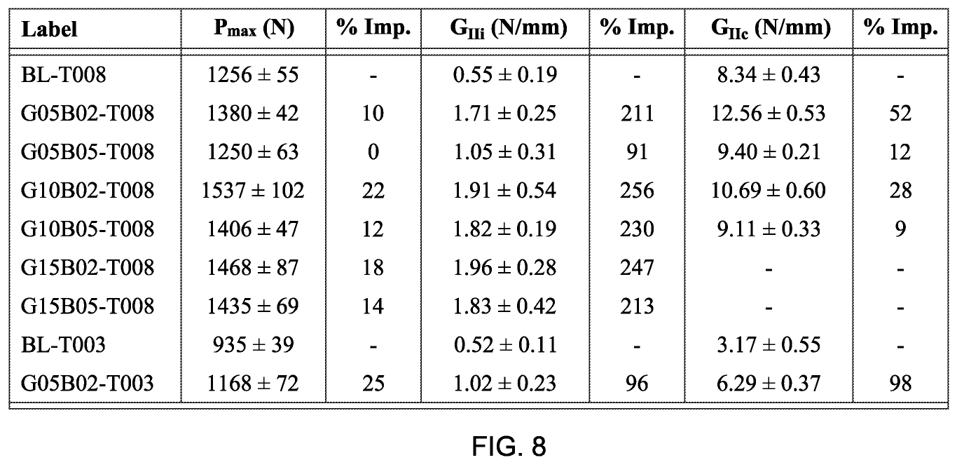

The table in FIG. 8 shows the maximum load Pₘₐₓ, the initiation and propagation fracture toughness (G_{IIi} and G_{IIc}, respectively), and the percentage increase compared to the baseline samples for all the tested samples. A global trend is evident, as the samples with the sacrificial cracks always show larger load and fracture toughness.

The collected results show that both the sacrificial crack 132’s width B and the gap g between two successive cracks influence the P – δ and G – aₑ responses. All tested samples with sacrificial cracks show larger Pₘₐₓ, G_{IIi} and G_{IIc} than the baseline samples. A sacrificial crack of 2 mm width B and 5 mm gap g improves the Pₘₐₓ, G_{IIi} and G_{IIc} by 10%, 211% and 52%, respectively. The Pₘₐₓ improvement rate and G_{IIi} are increased to 22% and 256% for g = 10 mm. This improvement is due to the larger path of the secondary crack to grow at the lower interface, which allows more energy dissipation and hence higher initiation fracture toughness.

Moreover, the presence of the sacrificial crack out of the FPZ of the initial crack allows larger deformation inside the adhesive layer, which stores higher elastic energy inside the adhesive, at the tips of the sacrificial crack, and hence improves Pₘₐₓ and G_{IIi}. Increasing the crack width decreases Pₘₐₓ, G_{IIi} and G_{IIc} due to the reduced interfacial area that allows cracks to grow at both interfaces. For B = 5 mm, the interfacial area that allows for crack propagation is reduced by 3 mm at each sacrificial crack compared to B = 2 mm. According to linear elastic fracture mechanics, the fracture toughness is proportional to the crack length; thus, the reduced crack length in this case results in reduced fracture toughness. Again, this is true for all cases; however, the percentage of improvement for B = 5 mm is less than that for B = 2 mm, and the Pₘₐₓ, G_{IIi} and G_{IIc} are still larger than the baseline joint.

The effect of the adhesive thickness on the strength of the joint is now discussed. The inventors have observed that the improvement of Pₘₐₓ and fracture toughness due to the sacrificial cracks is larger for thin adhesives. For the G05B02-T003 joint, the Pₘₐₓ, G_{IIi}, and G_{IIc} are improved by 25%, 96%, and 98%, respectively, compared to the BL-T003. For thin adhesive bondlines, the FPZ is small, and stresses are very concentrated at the crack tip, resulting in earlier crack growth and hence lower strength and toughness than thicker adhesive bondlines. The presence of sacrificial cracks redistributes the stresses inside the adhesive layer, which increases the FPZ and hence retards the crack propagation.

For the joint 300 shown in FIG. 3, double cantilever beam (DCB) tests were performed to characterize the mode I interlaminar fracture toughness. From these tests, the bonded joints were cut into samples of 20 mm width and 150 mm length. The tests were performed using a universal testing machine under displacement control at a loading rate of 1 mm/min. In-situ crack growth and damage mechanisms were monitored using a high-resolution camera. In total, three samples were tested for each configuration. The R-curve of the tested DCB specimen was obtained using the closed-form solution, wherein the beam compliance was computed using the simple beam theory. The fracture toughness value G_{I}, and the corresponding effective crack length aₑ were evaluated as:

$${G}_{I} = {\left[\frac{9}{4} \frac{{P}^{4} ⋅ {δ}^{2}}{{b}^{3} ⋅ {E}_{x x} ⋅ I}\right]}^{\frac{1}{3}} , a n d$$

$${a}_{e} = {\left[\frac{δ ⋅ b ⋅ {h}^{3} ⋅ {E}_{x x}}{8 P}\right]}^{1 / 3} - ζ ⋅ h ,$$

where P is the load, δ is the applied displacement at the loading point, b is the sample width, Eₓₓ is the in-plane modulus in the fiber direction, I is the second moment of area, h is the adherend thickness, and ζ is a correction factor that compensates for the assumption that the compliance at the crack root is zero; this differs from the real response in which some deflection and rotation occur at the crack tip. The correction factor ζ can be computed as:

$$ζ \text{=} {\left(\frac{{E}_{x x}}{11 {G}_{x y}}\right)}^{1 / 2} {\left[3 - 2 {\left(\frac{γ}{1 + γ}\right)}^{2}\right]}^{1 / 2} ,$$

where

$$γ = \frac{1.18}{{G}_{x y}} {\left({E}_{x x} ⋅ {E}_{y y}\right)}^{1 / 2} , {\text{E}}_{\text{yy}}$$

is the in-plane modulus in the direction perpendicular to the fiber direction, and G_{xy} is the in-plane shear modulus.

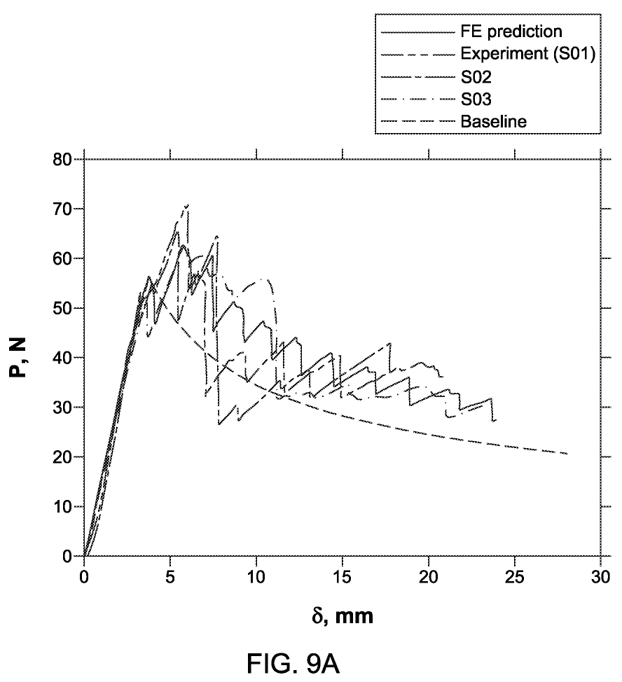

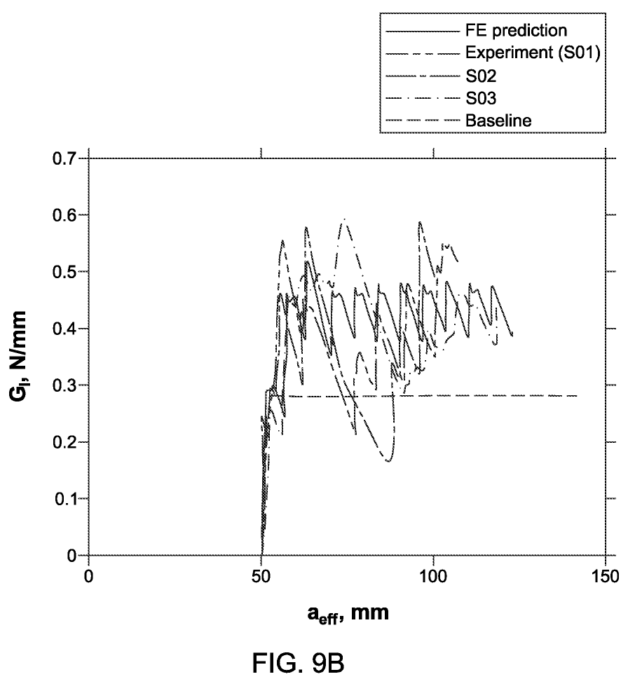

The finite element method (FEM) was applied to predict the load-displacement and the R-curve to simulate the DCB test. A fine mesh was used for these calculations. FIGS. 9A and 9B compare the FEM predictions to the experimental load-displacement and R-curves for three samples S01 to S02 for the joint 300 with B = 2 mm, g = 5 mm, and h_{c} = 120 µm. FIGS. 9A and 9B show an excellent correlation between the predicted and experimental results for the baseline joint at the propagation stage because the interface toughness that was fed to the model was determined experimentally, and the average fracture toughness was 0.28 N/mm. However, at the initiation of the propagation, the simulation load and toughness were underestimated. This is due to the initiation of the crack at the adhesive layer mid-plane in the experiments, where the pre crack exists. Then, the crack propagates inside the adhesive layer until reaching the lower interface, which required more energy to propagate. However, in the simulation, the crack initiation was forced at the lower interface. The model predicted the experimental load-displacement curve and R-curve of the joint 300 well. The load-displacement curve and R-curve for the joint 300 differed from those for the baseline joint, wherein the propagation load is relatively smooth for the baseline joint while it propagates in sawtooth shape for the joint 300. This difference between the global shape of the curves reflects the change in the crack propagation mechanisms. The toughening mechanism and crack propagation are similar to those discussed with regard to FIGS. 7A to 7E with regard to the joint 100, and thus these explanations are omitted herein.

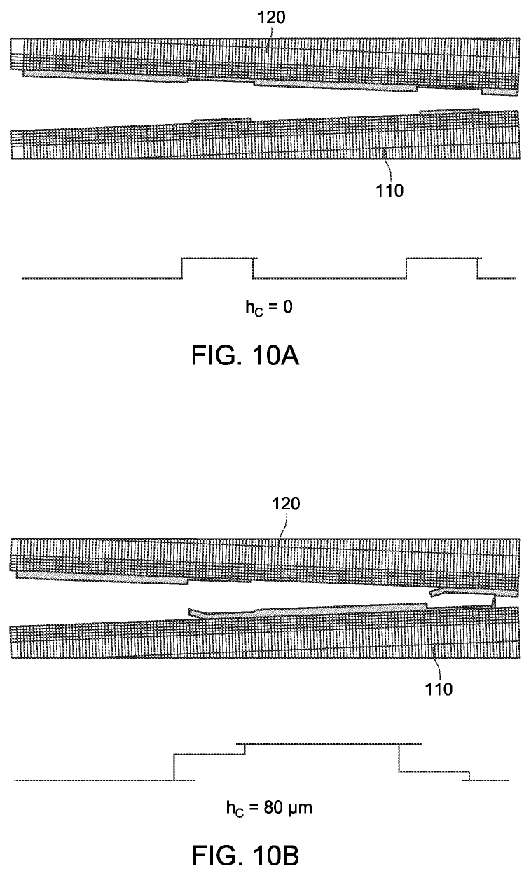

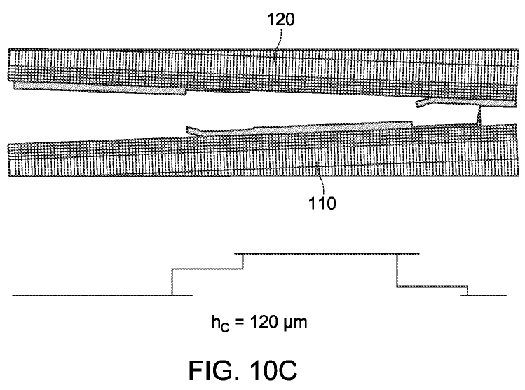

The effect of the offset h_{c} from the mid-plane 310 (see FIG. 3) on the joint 300 adhesive’s topology has also been studied as now discussed. The damage mechanisms in the joint 300 with 0.2 mm adhesive thicknesses is illustrated in FIGS. 10A to 10C. For sacrificial cracks located at the center of the bondline, i.e., h_{c} = 0, cracks always propagated at the lower interface as illustrated in FIG. 10A, inhibiting the formation of ligaments and hence the dissipation in the secondary and backward cracks. This case, h_{c} = 0, proves that ligaments formation generates high energy dissipation because if the energy dissipated via ligament plastic deformation and breakage is identical to crack propagation, then the load-displacement response and fracture energy should be lower than those of the baseline joint. The energy dissipated after 66 mm of crack propagation reached the same energy level as that of the baseline. However, in this case, 10 sacrificial cracks existed, indicating that the propagated crack path was reduced by 20 mm. Hence, the energy lost because of the sacrificial cracks was compensated by the energy dissipated in the adhesive break. The summation of the adhesive breakage at 10 sacrificial cracks was 2 mm. Therefore, 2 mm propagation in the adhesive was equivalent to 20 mm propagation at the interface, highlighting the role of the adhesive break as an important source of energy dissipation in the joint 300.

For the h_{c} > 0 cases, the response was almost the same for h_{c} = 80 and 120 µm, as illustrated in FIGS. 10B and 10C, respectively. This indicates that if the offset from the mid-plane 310 is introduced to break the symmetry, crack migration occurs and adhesive ligaments are formed, resulting in secondary and backward crack propagation, which improves the system fracture energy, and the exact value of h_{c} is not significant. The total energy stored in the system before ligament break G_{T}, was 0.37 N/mm, and the fracture energy G_{Ic}, was 0.32 N/mm. This energy was 0.28 N/mm for the baseline joint. Notably, the energy exhibits progressive increase with increasing the effective crack length due to the accumulation of energy dissipated in adhesive ligament breakage.

Comparing the total and fracture energy of the joint 300 obtained for adhesive thicknesses of 0.2 and 0.4 mm, respectively, reveals higher total and fracture energies for the latter thickness. This is because of the larger volume of adhesive breaking when the adhesive is thicker, which dissipates more energy. Moreover, thick ligaments, which were formed in the thick adhesives, break at a higher load, enabling further propagation of the secondary and backward cracks, I_{S} = 0.9 and 0.4 mm and I_{b} = 0.2 and 0.1 mm, for thick and thin adhesives, respectively.

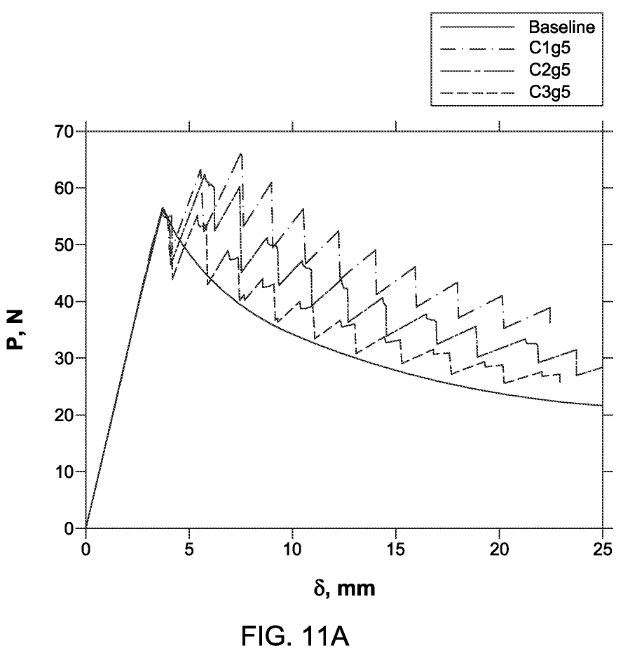

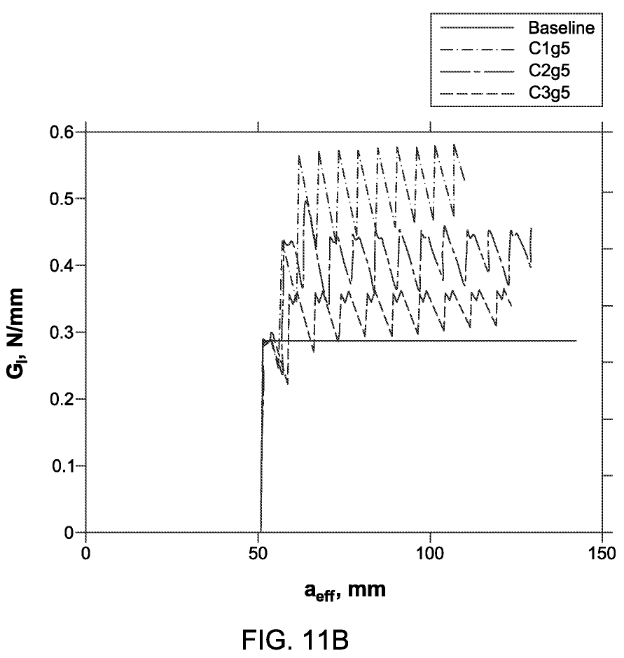

The effect of the sacrificial crack length B (which corresponds to the strip part 144’s width B) on the P –δ and R-curve of the joint 300 with an offset from the mid-plane of h_{c} = 120 µm and adhesive thickness of 0.4 mm is shown in FIGS. 11A and 11B. Increasing the width B reduces the maximum load and mode I toughness of the joint through the reduction of the energy dissipated in nonlocal damage mechanisms, crack migration, secondary and backward cracks, and ligament break. The increased B reduces the number of ligaments formed as well as secondary and backward cracks, which reduces the global energy dissipated by the system. Moreover, for small B, the allowed area for crack propagation increases, thereby increasing the fracture toughness. Therefore, the activation of the nonlocal damage mechanisms is associated with the presence of cracks rather than the crack length B. After a sacrificial crack is generated, even at a length of 1 mm, the nonlocal damage mechanisms are activated and higher energy dissipation occurs, improving the fracture toughness. Notably, the total energy G_{T} is reduced with increasing the length B owing to the reduction in the number of broken ligaments that store the elastic energy.

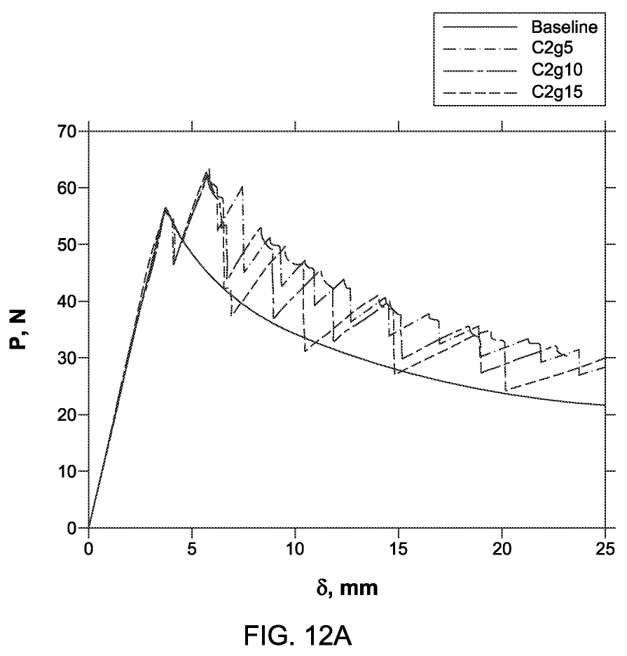

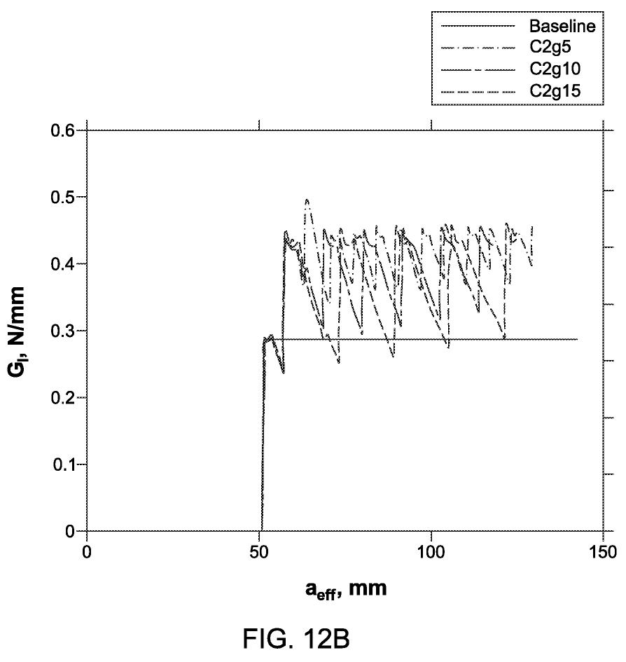

The effect of the gap between two successive sacrificial cracks g on the DCB response of the joint 300 is shown in FIGS. 12A and 12B. As expected, increasing the gap g reduces the interlaminar fracture toughness due to the reduction in the number of ligaments formed. This improvement in fracture toughness is proportional to the number of broken ligaments, the length of the secondary and backward cracks, and the total length allowed for crack propagation. Increasing the gap g increases the allowed length for crack propagation, which improves the fracture toughness. However, it reduces the generation of nonlocal damage mechanisms expressed by the number of crack migrations and ligaments, which prevents fracture toughness improvement. The negative effect of increasing g (the reduction in the number of ligaments) is larger than the positive effect (increasing allowed crack propagation area) of this parameter. Therefore, for the current analysis, a joint with small B and small g exhibits the best G_{Ic} improvement (67%) over that of the baseline, achieving a value of G_{Ic} = 0.47 N/mm against the baseline value of G_{Ic} = 0.28 N/mm.

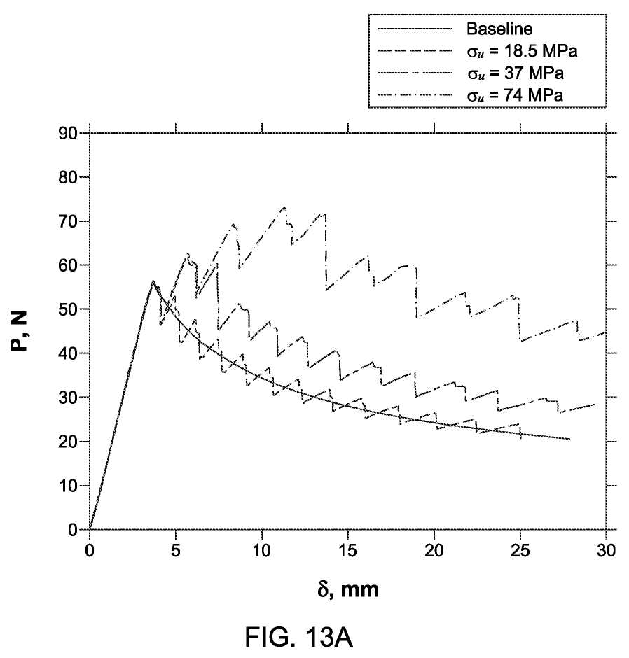

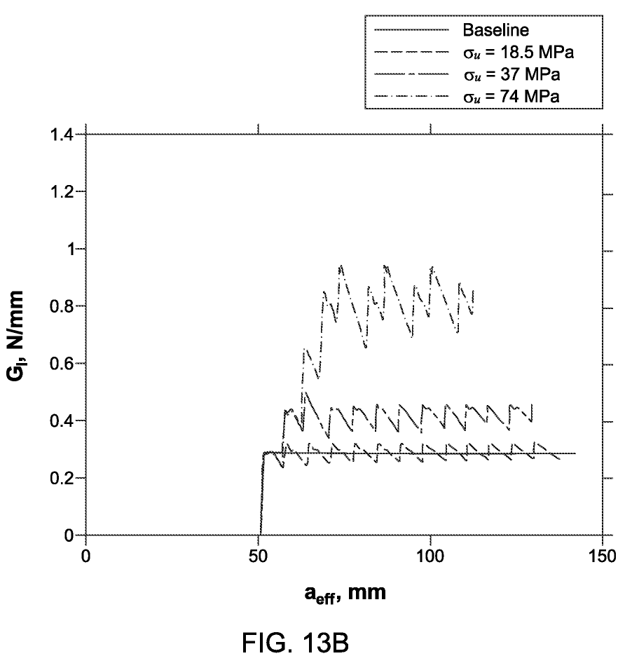

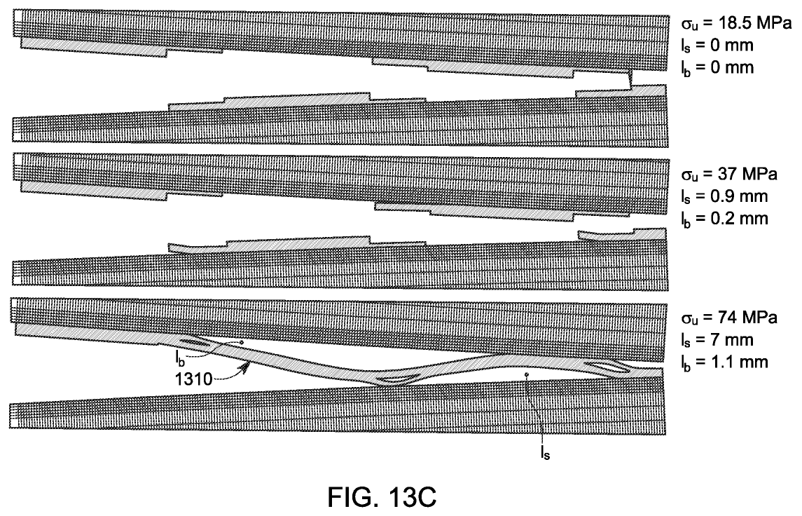

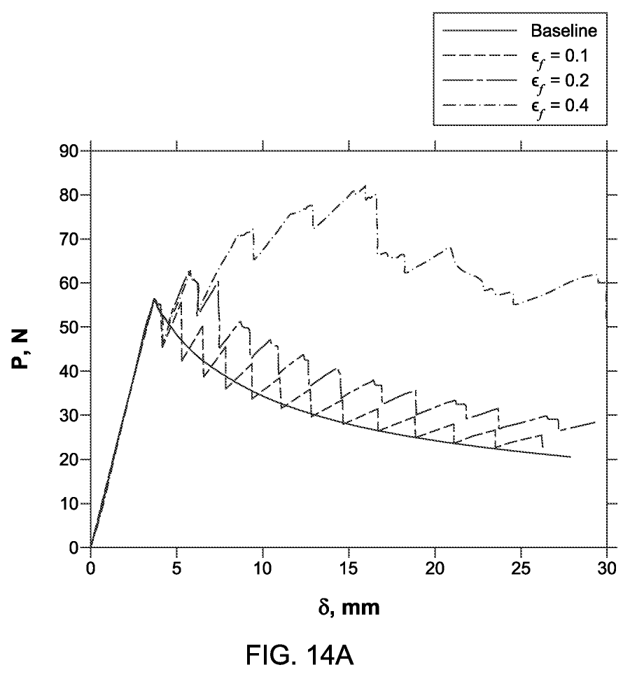

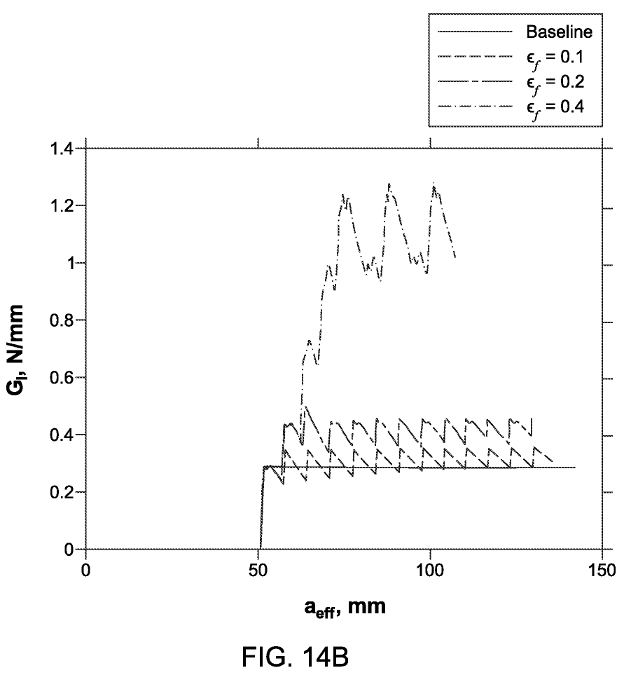

The effect of the adhesive properties on the joint 300 has also been analyzed. The adhesive’s mechanical properties can be tailored in bonded joints owing to the availability of commercial adhesives with distinct properties and the ability to tailor certain properties, such as strength or failure strain, using different materials: e.g., ceramics, metals, and thermoplastics inclusions. The effect of the adhesive strength σᵤ, and failure strain ∈_{ƒ} on the DCB response for the joint is shown in FIGS. 13A to 14B (all graphs are for a joint characterized by B = 2 mm, g = 5 mm, and h_{c} = 120 µm). These figures show the significant effect of both properties on the P – δ and R-curve responses. The joint’s maximum load and fracture toughness are proportional to the adhesive strength, as shown in FIGS. 13A and 13B. Doubling the adhesive strength from 37 MPa (Araldite adhesive strength) to 74 MPa improves the fracture toughness from 0.36 to 0.74 N/mm. In the current joint 300, the nonlocal damage mechanisms result from crack migration to the other interface and create an adhesive ligament 1310 that prominently participates in the dissipation. Doubling the adhesive strength inhibits ligament break and allows larger propagation of secondary and backward cracks, as shown in FIG. 13C. For the largest adhesive strength, σᵤ = 74 MPa, the secondary and backward cracks equal ls = 7 mm and lb = 1.0 mm, compared to Is = 0.9 mm and lb = 0.2 mm for the adhesive with a strength of 37 MPa. Reducing the adhesive strength to half, 18.5 MPa, makes it lower than the strength of the baseline joint, causing earlier breakage of the ligament before the propagation of the secondary and backward cracks. Therefore, despite the crack migrating to the other interface, the secondary and backward cracks do not propagate, and the only extra dissipation mechanism is ligament breakage as shown in FIG. 13C. In this case, owing to the adhesive’s lower strength, the energy required to break these ligaments is relatively small; thus, the global fracture energy is slightly smaller than that of the baseline joint.

The effect of the adhesive failure strain ∈_{ƒ} on the P – δ and R-curve responses of the joint 300 is shown in FIGS. 14A and 14B. Increasing the failure strain improves the P – δ and R-curve responses. Increasing the failure strain to 0.4 increases the joint maximum load to 81.4 N compared to 62.1 N and 55.6 N for the joint with a failure strain of 0.2 and the baseline joint, respectively, as illustrated in FIG. 14A. Moreover, the G_{Ic} increased to 1.04 N/mm compared to 0.36 and 0.28 N/mm for the joint 300 with a failure strain of 0.2 and the baseline joint, respectively, as shown in FIG. 14B. This improvement is attributed to the higher failure strain of the ligaments, which allows larger ligament deformation. Therefore, larger propagation of the secondary and backward cracks occurs, Is = 7 mm and lb = 1.6 mm, dissipating more energy and thus improving the fracture toughness. Decreasing the failure strain to 0.1 reduces the deformability of the adhesive ligaments, causing earlier ligament breakage. Therefore, the secondary crack propagation is very small, Is = 0.1 mm, whereas the backward crack propagation is inhibited, causing lower energy dissipation and hence lower fracture toughness, G_{Ic} = 0.28 N/mm; this fracture toughness is lower than that of the joint 300 with a failure strain of 0.2 and equal to that of the baseline joint.

The results discussed above indicate that the fracture toughness of the joint 300 can be tailored by changing either the adhesive strength or failure strain. These two properties can be tailored using thermoplastics, metals, and ceramics and enable the designing of bonded joints with different toughness values using the same adhesive. The fracture toughness of the same adhesive can be increased by 264% by strengthening the proposed joint’s adhesive with a factor of 2. Moreover, the toughness can be increased by 371% by increasing the failure strain by a factor of 2. Additionally, the toughness can be adjusted for specific applications at a certain level by controlling both parameters. It is valuable to note that for adhesives with very high failure strain or strength, where long bridging occurs as shown in FIG. 13C, the failure process zone is very large reaching the material characteristic length. In this case, the linear elastic fracture mechanics laws became inapplicable and nonlinear mechanics laws such as J-integral and cohesive models should be applied to characterize the interface proprieties. Thus, the crack propagation response becomes a function of the geometry of the joint.

The novel adhesive-based joint 100/300 shows improved interlaminar fracture toughness by generating sacrificial cracks inside the adhesive layer with specific topology that activates nonlocal dissipation damage mechanisms through the development of bridging ligaments. The various tests discussed above show that the damage mechanisms in the joint 100/300 differ from those of baseline adhesive joints. Unlike conventional adhesive joints, wherein the crack propagates at the lower adhesive/adherend interface, the crack in the novel joint migrates to the upper interface at the sacrificial crack position. This crack migration allows the formation of the adhesive ligament between the upper and lower adherends and the adhesive, leading to the propagation of a secondary crack at the lower interface under the sacrificial crack together with the propagation of a backward crack at the upper interface over the sacrificial crack (see FIG. 13C). The simultaneous propagation of these two cracks, dissipates more energy during fracture. Moreover, when the ligament deformation reaches its maximum deformability, it breaks, dissipating more energy. Therefore, three dissipation mechanisms are activated in the novel joint 100/300, secondary and backward crack propagation and ligament breakage, which increase the energy dissipation and improve fracture toughness. Decreasing the sacrificial crack width B and gap g between two successive cracks 132 improves the toughness due to the increase in the allowable surface for secondary and backward crack propagations. The adhesive properties significantly affect the toughness of the joint, wherein the toughness increases with increasing the adhesive strength and failure strain. The novel joint demonstrated herein can improve the interlaminar fracture toughness of bonded joints and provide progressive damage manner of the joint, thus improving safety and toughness in structural composite applications.

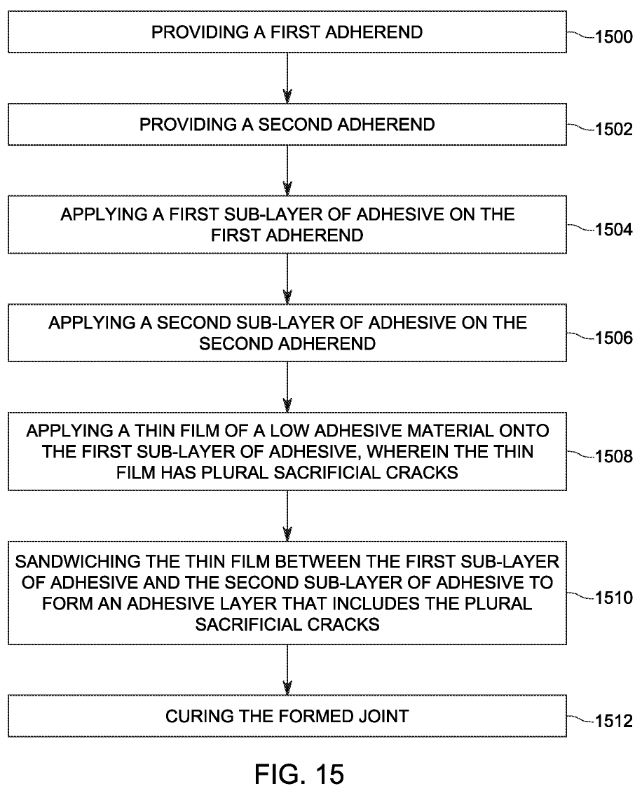

A method for manufacturing the joint 100/300 is now discussed with regard to FIG. 15. The method includes a step 1500 of providing a first adherend, a step 1502 of providing a second adherent, a step 1504 of applying a first sub-layer of adhesive on the first adherent, a step 1506 of applying a second sub-layer of adhesive on the second adherend, a step 1508 of applying a thin film of a low adhesive material onto the first sub-layer of adhesive, wherein the thin film has plural sacrificial cracks, a step 1510 of sandwiching the thin film between the first sub-layer of adhesive and the second sub-layer of adhesive to form an adhesive layer that includes the plural sacrificial cracks, and a step 1512 of curing the formed joint. The low adhesive material has an adhesion with the adhesive layer lower than an adhesion between the first or second adherends and the adhesive layer. The method may further include a step of applying another thin film of a low adhesive material onto the second sub-layer of adhesive, wherein the another thin film has additional plural sacrificial cracks.

The disclosed embodiments provide an adhesive-based joint with embedded sacrificial cracks that increase both mode I and II toughness fracture. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.

Chudnovsky and Wu, Effect of crack-microcracks interaction on energy release rates, International journal of fracture 1990; 44(1):43-56.

1. An adhesive-based joint comprising:
a first adherend;
a second adherend;
an adhesive layer located between the first adherend and the second adherend; and
plural strip parts of a low adhesive material embedded into the adhesive layer,
wherein the low adhesive material has an adhesion with the adhesive layer lower than an adhesion between the first or second adherend and the adhesive layer.

2. The joint of claim 1, wherein the plural strip parts are located in a middle plane of the adhesive layer, wherein the middle plane extends parallel to the first and second adherends.

3. The joint of claim 1, wherein the plural strip parts are equally separated along the middle plane with a gap of about 5 mm.

4. The joint of claim 3, wherein each strip part of the plural strip parts has a width of about 2 mm along the middle plane.

5. The joint of claim 4, wherein a thickness of the adhesive layer is less than 1 mm.

6. The joint of claim 1, wherein plural sacrificial cracks correspond to the plural strip parts, and the plural sacrificial cracks allow the propagation of extra nonlocal dissipation damage modes as (1) secondary cracks, away from a primary crack, and (2) backward cracks, toward the primary crack, when the primary crack appears.

7. The joint of claim 6, wherein the secondary and backward cracks generate a bonding ligament that extends between the first and second adherends.

8. The joint of claim 1, wherein a mode l fracture toughness is dependent of a position of the plural strip from the mid-plane, wherein to activate the nonlocal dissipation mechanisms an offset from the mid-plane should be ensured.

9. The joint of claim 1, wherein the plural strip parts are made of PTFE.

10. The joint of claim 1, wherein the plural strip parts are alternately distributed above and below a mid-plane of the adhesive layer.

11. The joint of claim 1, wherein a fracture toughness is tailored based on the sacrificial crack width and the gap between two successive cracks.

12. The joint of claim 1, wherein the first and second adherends are made of composite materials.

13. A joint comprising:
a first adherend;
a second adherend;
an adhesive layer located between the first adherend and the second adherend; and
plural sacrificial cracks embedded into the adhesive layer,
wherein the plural sacrificial cracks are filled with a low adhesive material that has an adhesion with the adhesive layer lower than an adhesion between the first or second adherends and the adhesive layer.

14. The joint of claim 13, wherein the plural sacrificial cracks are located in a middle plane of the adhesive layer.

15. The joint of claim 13, wherein the plural sacrificial cracks are equally separated along a middle plane of the adhesive layer, with a gap of about 5 mm, each sacrificial crack of the plural sacrificial cracks has a length of about 2 mm along the middle plane, and a thickness of the adhesive layer is less than 1 mm.

16. The joint of claim 13, wherein the plural sacrificial cracks propagate as (1) secondary cracks, away from a primary crack, and (2) backward cracks, toward the primary crack, when the primary crack appears.

17. The joint of claim 16, wherein the secondary and backward cracks generate a bonding ligament that extends between the first and second adherends.

18. The joint of claim 13, wherein a part of the plural sacrificial cracks is closer to the first adherend than the second adherend, and another part of the plural sacrificial cracks is closer to the second adherend than to the first adherend.

19. A method for manufacturing a joint with offset of sacrificial cracks from a mid-plane, the method comprising:
providing a first adherend;
providing a second adherend;
applying a first sub-layer of adhesive on the first adherend;
applying a second sub-layer of adhesive on the second adherend;
applying a thin film of a low adhesive material onto the first sub-layer of adhesive, wherein the thin film has plural sacrificial cracks;
sandwiching the thin film between the first sub-layer of adhesive and the second sub-layer of adhesive to form an adhesive layer that includes the plural sacrificial cracks; and
curing the formed joint,
wherein the low adhesive material has an adhesion with the adhesive layer lower than an adhesion between the first or second adherends and the adhesive layer.

20. The method of claim 19, further comprising:
applying another thin film of the low adhesive material onto the second sub-layer of adhesive, wherein the another thin film has additional plural sacrificial cracks.
